(19) United States
(12) Patent Application Publication
(10) Pub. No.: US 2012/0154226 A1
(43) Pub. Date: Jun. 21, 2012

(54) SINGLE UNIT ANTENNA FOR VARIOUS FUNCTIONS AND PORTABLE DEVICE INCLUDING THE SAME

(75) Inventors: Hong Gu Kim, Hwasung-si (KR); Jae Min Seo, Suwon-si (KR); Hyo Sun You, Suwon-si (KR)

(73) Assignee: SAMSUNG ELECTRONICS CO., LTD., Suwon-si (KR)

(21) Appl. No.: 13/326,237

(22) Filed: Dec. 14, 2011

(30) Foreign Application Priority Data
Dec. 16, 2010 (KR) 10-2010-0128858

(51) Int. Cl. H01Q 1/24; H01Q 1/50

(52) U.S. Cl. 343/702; 343/904; 343/876

(57) ABSTRACT

A portable device having a single unit antenna for various functions is provided. The device includes a main body configured to house a battery, a battery cover unit that is configured to be coupled with the main body and cover the battery, and a single unit antenna for various functions having a specified length, the antenna extending at least across a portion of the battery cover unit, and configured to support a plurality of functions.

### CROSS-REFERENCE TO RELATED APPLICATION(S) AND CLAIM OF PRIORITY

The present application is related to and claims the benefit of priority to Korean Patent Application No. 10-2010-0128858, filed on Dec. 16, 2010, in the Korean Intellectual Property Office, the disclosure of which is incorporated herein in its entirety by reference.

### TECHNICAL FIELD OF THE INVENTION

The present invention relates to an antenna of a device, and more particularly, to a single unit antenna for various functions and a portable device including the same, which can support to perform various functions based on a single unit antenna.

### BACKGROUND OF THE INVENTION

In recent years, a portable device is widely used based on its portability. In particular, mobile communication devices can have various other functions while maintaining transmission and reception of call information between speakers as a main function.

For example, a portable device according to a prior art may have an MP3 function corresponding to a file replay function or an image collecting function corresponding to a digital camera that can collect an image. Further, the portable device according to the prior art supports a function that can perform a mobile game or an arcade game, etc. In order to support the above-described various functions, the area of the display unit of a portable device is getting large, and the portable device includes high-performance hardware for including various functions. In addition, the portable device according to the prior art has a built-in module for supporting RFID and FM radio functions.

Such a portable device according to the prior art should have a built-in antenna corresponding to each operating frequency band in order to support various communication modules. For example, the portable device according to the prior art should include an antenna corresponding to the frequency band operated by a mobile communication module for supporting a mobile communication function, an antenna corresponding to the frequency band operated by a broadcast reception module for supporting a broadcast reception function, an antenna corresponding to the frequency band for RFID function operation for supporting a RFID function, and an antenna corresponding to the frequency band for FM radio function operation for supporting a FM radio function, etc. However, as described above, the portable device according to the prior art includes elements for supporting various functions and size thereof is being gradually reduced in order to improve portability thereof, and thus has a limitation in securing space for installing various antennas. In particular, depending on the type of a device, a certain portable device should basically provide a mobile communication function, and thus it is difficult to secure appropriate space for installing antennas for supporting other functions. Therefore, there is a need for efforts to solve an appropriate antenna arrangement issue in order to support various functions in a portable device.

### SUMMARY OF THE INVENTION

To address the above-discussed deficiencies of the prior art, it is a primary object to provide a single unit antenna for various functions of a portable device using one antenna.

The present invention further provides a single unit antenna for various functions and a portable device in which the functions include a RFID function and an FM radio function configured to operate at the same time using the one antenna.

The present invention further provides a single unit antenna for various functions, which can make a portable device slim by saving antenna installation space for various user functions in certain embodiments.

In accordance with an aspect of the present invention, a portable device includes a single unit antenna for various functions includes a main body configured to house a battery, a battery cover unit configured to be coupled with the main body and cover the battery, and a single unit antenna having a specified length, the antenna extending across at least a portion of the battery cover unit and configured to support a plurality of functions.

In accordance with another aspect of the present invention, a single unit antenna for various functions of a portable device includes an antenna pattern having a specified length that extends at least across a portion of a battery cover unit, a first antenna connection point and a second antenna connection point formed with a specified surface area at both end points of the antenna pattern, and a third antenna connection point disposed with the specified surface area on the antenna pattern between the first antenna connection point and the second antenna connection point.

In accordance with another aspect of the present invention, a single unit antenna for various functions of a portable device includes an antenna pattern that extends over at least a portion of a battery cover unit, the antenna pattern including a front side antenna pattern and a rear side antenna pattern which are placed separately from each other at regular intervals, a first antenna connection point having a specified surface area at one end of the front side antenna pattern, a second antenna connection point having the specified surface area at one end of the rear side antenna pattern, a third antenna connection point having the specified surface area at the other end of the front side antenna pattern, and a fourth antenna connection point having the specified surface area at the other end of the rear side antenna pattern, and a switch that is disposed between the third antenna connection point and the fourth antenna connection point, the switch configured to selectively connects the third antenna connection point and the fourth antenna connection point.

As described above, certain embodiment of a single unit antenna for various functions of a portable device including the same according to an exemplary embodiment of the present invention saves antenna installation space by using one antenna in order to support various functions of the portable device.

Further, certain embodiments of the present invention can support more various user functions by saving antenna installation space.

Further, certain embodiments of the present invention support to make a portable device slim by saving antenna installation space.

Before undertaking the DETAILED DESCRIPTION OF THE INVENTION below, it may be advantageous to set forth definitions of certain words and phrases used throughout this patent document:

the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an external appearance of a portable device according to an exemplary embodiment of the present invention;

FIG. 2 illustrates another form of an antenna pattern disposed at the battery cover unit of FIG. 1;

FIG. 3 illustrates an external appearance of a portable device according to another exemplary embodiment of the present invention;

FIG. 4 is a block diagram illustrating a configuration of a portable device according to an exemplary embodiment of the present invention;

FIG. 5 illustrates operation of a single unit antenna for various functions according to an exemplary embodiment of the present invention; and

FIG. 6 illustrates operation of a single unit antenna for various functions according to another exemplary embodiment of the present invention.

### DETAILED DESCRIPTION OF THE INVENTION

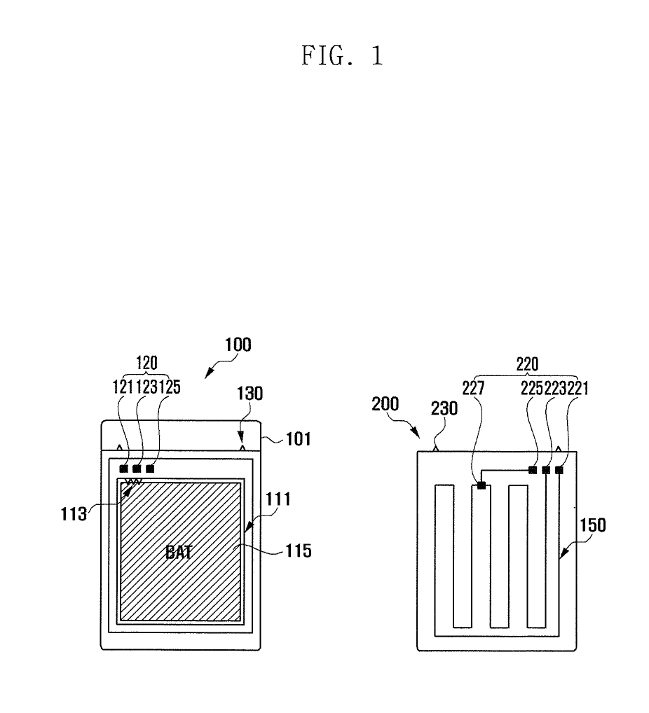

FIGS. 1 through 6, discussed below, and the various embodiments used to describe the principles of the present disclosure in this patent document are by way of illustration only and should not be construed in any way to limit the scope of the disclosure.

Those skilled in the art will understand that the principles of the present disclosure may be implemented in any suitably arranged portable units. The same reference numbers are used throughout the drawings to refer to the same or like parts. Detailed descriptions of well-known functions and structures incorporated herein may be omitted to avoid obscuring the subject matter of the present invention.

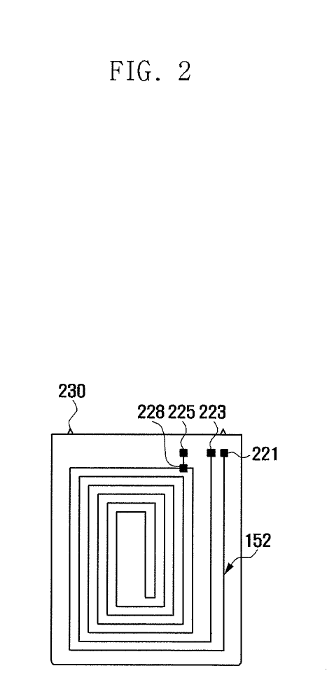

FIGS. 1 and 2 illustrate an example portable device 100 including a single unit antenna according to an embodiment of the present invention.

Referring to FIGS. 1 and 2, the portable device 10 according to the present invention may include a main body 100 and a battery cover unit 200.

The portable device 10 having such a configuration may include a single unit antenna 150 for various functions, such as a radio-frequency identification (RFID) function and a frequency modulation (FM) radio function in the main body 100. As such, the portable device 100 of the present invention can selectively operate various functions using one antenna by selectively operating the RFID function and the FM radio function.
Hereinafter, the external appearance of the portable device 100 will be explained in more detail. The main body 100 may include a case 101 covering a controller, a display unit and an input unit, etc., a battery 115 for supplying power to the portable device 10, a battery compartment 111 for battery placement in one side of the case 101, a power connection terminal unit 113 for connecting various internal components such as a mainboard to the battery 115, main body antenna connection points 120 having a specified surface area and placed on the main body 100 to be connected to specified terminals of the single unit antenna 150.

The case 101 can have any suitable size and shape. For example, the case 101 can have a shape and size that improves a sense of grip of the portable device 10 while protecting the components of the portable device 10 from external impact by covering the components. Such a case 101 can be made of plastic or metal, etc., and the front surface of the case 101 can be formed in a structure that covers the outline of the display unit in order to expose the displayed area of the display unit. In addition, the rear surface of the case 101 can be formed in a structure that exposes the area, where the battery compartment 111 is disposed, to the outside. Further, a main body hook structure 130 can be disposed at one side of the case 101 in order to fix the cover unit 200 when the battery cover unit 200 is arranged to cover the area where the battery compartment 111 is disposed.

The battery 115 is disposed at the battery compartment 111, is connected to the power connection terminal unit 113, and supplies power that is necessary for operating the portable device 10. Such a battery 115 can be a rechargeable secondary battery. The battery 115 can have a shape and size that is essentially similar to that of the battery compartment 111 for being placed thereinto.

Further, a power link terminal unit can be disposed on the main body for connection to the power connection terminal unit 113.

The battery compartment 111 may be formed on the rear surface of the portable device 10. The battery compartment 111 may also be formed with a step difference from the rear surface of the case 101 toward the front surface of the case 101. Further, the power connection terminal unit 113 can be disposed at one side of the battery compartment 111 to make contact with the power link unit when the battery 115 is inserted into the compartment 111. In addition, in case the portable device 10 supports Subscriber Identification Module (SIM) card operation, a SIM card interface, into which the SIM card can be inserted, can be disposed at one side of the battery compartment 111, for example, the bottom surface of the battery compartment 111. The SIM card interface can be disposed in a form with a step difference from the bottom surface of the battery compartment 111 toward the front surface of the battery compartment 111.

The main body antenna connection points 120 include first, second, and third main body antenna connection points 121, 123, and 125. These connection points 121, 123, and 125 can be disposed on the main body adjacent to each other in order to support various functions. When the battery cover unit 200 is coupled to the case 101 in order to cover the battery 115, the main body antenna connection points 120 are placed to make contact with cover unit antenna connection points 220 disposed on the battery cover unit 200. That is, the first main body antenna connection point 121 can make contact with the first cover unit antenna connection point 221 disposed on the battery cover unit 200, the second main body antenna connection point 123 can make contact with the second cover unit antenna connection point 223, and the third main body antenna connection point 125 can make contact with the third cover unit antenna connection unit 225. The first main body antenna connection point 121, which makes contact with the first cover unit antenna connection point 221, and the second main body antenna connection point 123, which makes contact with the second cover unit antenna connection point 223, can be connection points for supporting a firs user function, such as a 13 Mega-Hertz (MHz) band RFID function. Further, the first main body antenna connection point 121 and the third main body antenna connection point 125, which make contact with the third cover unit antenna connection point 225, can be connection points for supporting a second user function, such as a 100 MHz band FM radio function.

The battery cover unit 200 may be made of any suitable material. In one embodiment, the battery cover unit 200 maybe made of a material similar to that of the case 101, and can cover some or all of the area where the battery 115 is disposed at the rear surface of the case 101. In particular, the battery cover unit 200 of the present invention can have an antenna pattern, which can support various user functions of the portable device 10. In the particular embodiment shown the battery cover unit 200 also includes a cover unit hook structure 230, which can be coupled with the main body hook structure 130 disposed at the case 101 when the battery cover unit 200 is coupled to the main body 100.

The single unit antenna 150 supports functions that use an antenna, such as one that may be configured in a zigzag form. Such a single unit antenna 150 can be installed at the bottom surface of the battery cover unit 200 in a certain pattern, and covered with an insulating material for preventing wear and/or electrical contact with other structures. For example, a sticker made of an insulating material, can be disposed at the front surface of the pattern mounted single unit antenna 150.

In certain embodiments, the single unit antenna 150 can have an antenna length that provides resonance with a frequency band for a RFID function. In addition, the single unit antenna 150 can have an antenna length that provides resonance with a frequency band for a FM radio function. The antenna length for the first user function support may be greater than the antenna length for the second user function support. In order to provide an antenna length for the second user function, a connection point can be made at a certain point in a pattern of the antenna that may be coupled to the second user function. The first user function can also be selectively used by coupling to the other terminals such that the antenna exhibits an “Open Stub” effect.

The cover unit antenna connection points 220 are formed with a certain surface area on the main body 100. These points 220 include the first cover unit antenna connection point 221 that may be connected to the first main body antenna connection point 121, the second cover unit antenna connection point 223 that may be connected to the second main body antenna connection point 123, the cover unit antenna connection point 225 that may be connected to the third main body antenna connection point 125. A fourth cover unit antenna connection point 227 disposed at a specified point on the single unit antenna can further include a signal line that connects the fourth cover unit antenna connection point 227 with the third cover unit antenna connection point 225. The cover unit antenna connection points 220 can be disposed externally on the battery cover unit 200. The fourth cover unit antenna connection point 227 and the signal line may be formed internally inside the battery cover unit 200. In one embodiment, exposure of the fourth cover unit antenna connection point 227 and the signal line can be prevented by a sticker disposed at the upper part of the single unit antenna 150. The length of the single unit antenna 150, which connects the first cover unit antenna connection point 221 and the second cover unit antenna connection point 223, can be any length for supporting the first user function. Further, the antenna length between the first cover unit antenna connection point 221 and the fourth cover unit antenna connection point 227 can be an antenna length for supporting the second user function.

FIG. 2 illustrates an example single unit antenna 152 according to one embodiment of the present disclosure. This single unit antenna 152 may be configured in the battery cover unit 200. The single unit antenna 152 can be configured in a cochlea-shaped ring form as shown. As such, the fourth cover unit antenna connection point 227 can be disposed at a certain point of a ring-shaped pattern of the single unit antenna 150 for various functions, and a signal line, which is connected to the third cover unit antenna connection point 225, can be additionally disposed.

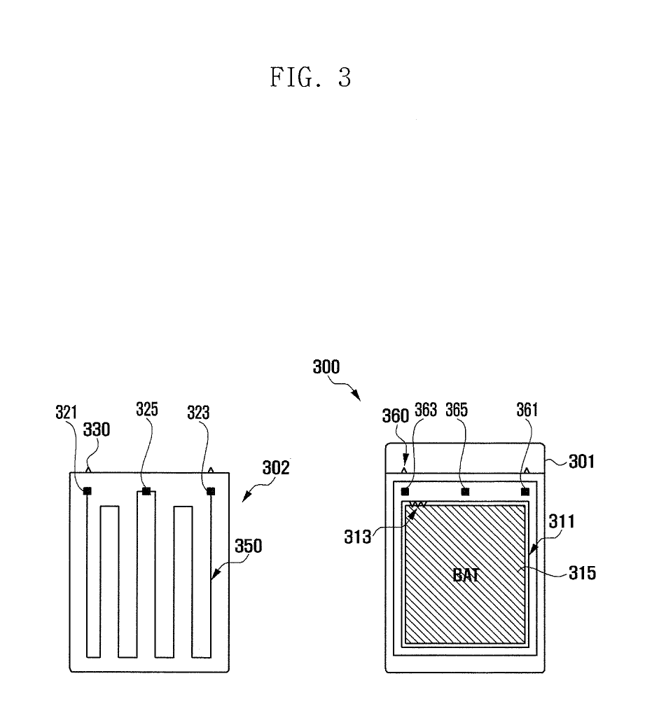

FIG. 3 illustrates an example portable device 300 according to another embodiment of the present invention.

Referring to FIG. 3, the portable device 300 includes a single unit antenna 350, which is disposed in a battery cover unit 302. The single unit antenna 350 is configured in a zigzag form, and has cover unit antenna connection points 321, 325, and 323 that can be disposed at the upper part of the bottom surface of the battery cover unit 302 in a row at fixed intervals. That is, the first cover unit antenna connection point 321 is disposed proximate the left edge area, and the second cover antenna connection point 323 can be disposed proximate the right edge area, and the third cover unit antenna connection point 325 can be disposed between the first cover unit antenna connection point 321 and the second cover unit antenna connection point 323. The third cover unit antenna connection point 325 can be directly disposed at a suitable specified point on the pattern of the single unit antenna 350. As such, the battery cover unit 302 may be void of the fourth cover unit antenna connection point as shown in FIG. 1.

For the single unit antenna 350 having such a configuration, the first cover unit antenna connection point 321 and the third cover unit antenna connection point 325, which is disposed between the first cover unit antenna connection point 321 and the second cover unit antenna connection point 323, can work as a connection point for a FM radio function, while the second cover unit antenna connection point 323, which is disposed at a certain distance from the first cover unit antenna connection point 321, can work as a connection point for supporting the RFID function.

Further, the positions of antenna connection points, which are disposed at one side of the main body 300, can be determined according to the arrangement of connection points of the single unit antenna 350 for various functions of the battery cover unit 302. That is, the first main body antenna connection point 361 can be disposed in the right edge area to make contact with the first cover unit antenna connection point 321 which is disposed at the left edge area of the bottom surface of the battery cover unit 300 when coupled with the battery cover unit 302. In addition, the second main body antenna connection point 363 is disposed at the left edge area and can be contacted with the second cover unit antenna connection point 323 when coupled with the battery cover unit 302. The third main body antenna connection point 365 is disposed between the first main body antenna connection point 321 and the second main body antenna connection point 323, and can be contacted with the third cover unit antenna connection point 325 when coupled with the battery cover unit 302.

As described above, certain embodiments of the single unit antenna 350 may support multiple functions using one antenna pattern.

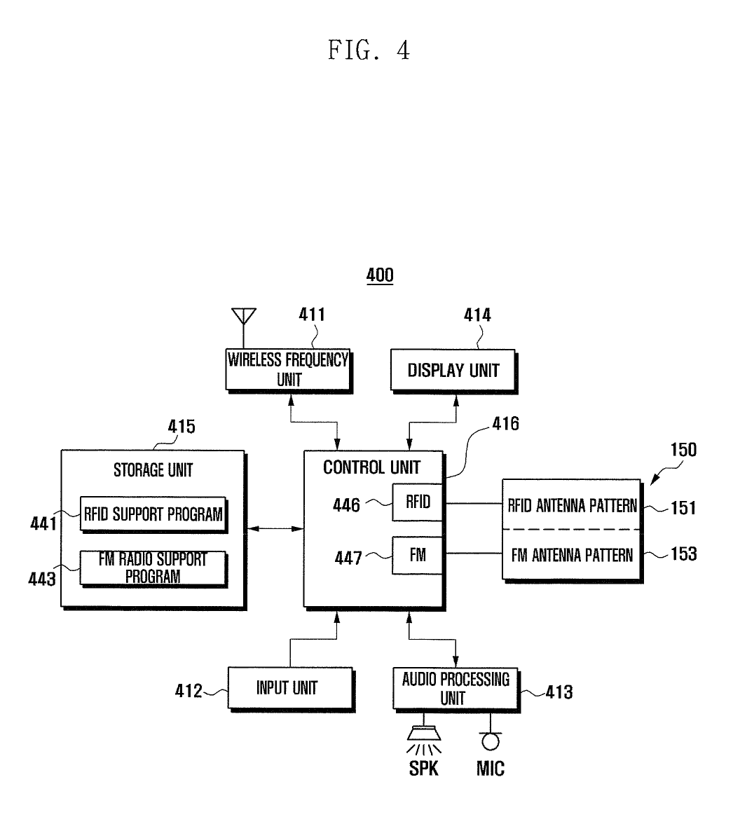

FIG. 4 illustrates an example configuration of a portable device 400 for operation of a single unit antenna 150 according to an embodiment of the present invention.

Referring to FIG. 4, the portable device 400 can include a wireless frequency unit 411, an input unit 412, an audio processing unit 413, a display unit 414, a storage unit 415, a single unit antenna 150 for various functions and a controller 460.

The portable device 400 having such a configuration can use the single unit antenna 150 for various functions such as a RFID antenna pattern 151 or as a FM radio antenna pattern 153 according to an input signal inputted from an input unit 412 and a display unit 414 with a touch screen function in operating the single unit antenna 150. Hereinafter, with respect to operation of the single unit antenna 150, the role and the function for each component will be explained in more detail.

The wireless frequency unit 411 is a component for supporting a communication service of the portable device 400. Such a wireless frequency unit 411 can be of a form of a modem that can support at least one of various communication methods, for example, a mobile communication modem such as a CDMA, WCDMA and GSM, etc. and a mobile data communication modem such as a HSDPA and Wibro, etc. The wireless frequency unit 411 forms a communication channel for a voice call and forms a communication channel for image or video transmission or data transmission based on transmission and reception of data under the control of a controller 416. That is, the wireless frequency unit 411 forms a voice call channel, a data communication channel and a video call channel, etc. between communication systems.

To this end, the wireless frequency unit 411 can include a transmission unit that up-converts and amplifies the frequency of a transmitted signal and a plurality of reception units that low-noise-amplify and down-convert the frequency of a received signal. The wireless frequency unit 411 can include an antenna. The antenna can be disposed inside the case of the portable device 400, or can be disposed in an antenna pattern form. In case the portable device 400 does not support a separate mobile communication service, the wireless frequency unit 411 can be omitted.

The input unit 412 includes several input keys and function keys for receiving the input of number or letter information and setting various functions. The function keys can include a direction key, a side key and a shortcut key which are set to perform a certain function. In case the portable device 400 adopts a full touch screen, the input unit 412 can include only the touch screen and the side key formed at one side of the case while not adopting a separate key button or key pad. In case the portable device 400 adopts the touch screen, such an input unit 412 can be implemented by a key map and including several keys and a touch panel setting according to the key map. The key map can include a QWERTY key map, a numeric key map having a ‘3’ by ‘4’ configuration, a menu map, and a soft key map, and the like. In particular, the input unit 412 according to the present invention can generate an input signal for selecting a certain user function based on the single unit antenna 150 for various functions according to the control by the user. That is, the input unit 412 can generate an input signal for activation of a RFID function and an input signal for activation of a FM radio function, and the like according to user' s control, and transmit a generated input signal to the controller 416. Here, when a tag function is performed in supporting the RFID function, the tag function can be performed without a separate input signal generation.

The audio processing unit 413 includes audio data, which is transmitted and received during a call, a speaker (SPK), which outputs audio data included in a received message and audio data stored in the storage unit 415, and a microphone (MIC), which collects user's voice or other audio signals during a call. Such an audio processing unit 413 can output an alarm according to the performance of a user function. For example, the audio processing unit 413 can output a signal that alarms activation of a RFID function and a signal that alarms activation of a FM radio function, etc. Such an output of an alarm signal can be omitted according to a user setting, etc.

The display unit 414 displays information inputted by user or information provided to user as well as various menus of the portable device 400. That is, the display unit 414 can provide various screens according to the use of the portable device 400, for example, an idle screen, a menu screen, a message writing screen, and a call screen, etc. Such a display unit 414 can be formed by various display devices such as a liquid crystal display (LCD) and an organic light emitted diode (OLED), etc. Further, in case the display unit 414 is manufactured in the form of a touch screen along with a touch panel disposed on the upper side, the display unit 414 can work as the input unit 412. In particular, the display unit 414 of the present invention can output a screen related with operation of the single unit antenna 150 for various functions of the present invention during activation of each user function. That is, the display unit 414 can output an icon or an indicator which directs activation of a RFID function, and output an icon or indicator that directs FM radio function activation, data received based on the FM radio function activation, and a screen for setting frequency and volume related with the FM radio function. In addition, the display unit 414 can output information corresponding to a receiving sensitivity of the FM radio antenna pattern 153 in operating the FM radio function.

The storage unit 415 can include an application program that is necessary for operating a function according to an exemplary embodiment of the present invention, and can include a key map for operation of a touch screen in case the portable device 400 is formed as a touch screen. The key map may include a key map, a menu map and a soft key map, and the like. The key map and the menu map can be formed in various forms, respectively. That is, the key map may be a keyboard map, a numberic key map, and a QWERTY key map, and the like, or may be a control key map for controlling operation of a currently activated application program. Further, the menu map can be a menu map for controlling operation of a currently activated application program, or can be a menu map having various menus provided by the portable device 400 as a list. Such a storage unit 415 can include a program area and a data area.

The program area can store an operating system (OS) for booting the portable device 400 and operating each component of the portable device 400, and an application program for replaying various files, for example, an application program for supporting a calling function depending on the portable device 400, a web browser for connecting to an Internet server, an MP3 application program for replaying sound sources, an image output application program for displaying a picture, and the like, and a moving picture replay application program, and the like. In particular, the program area of the present invention can store a RFID support program 441 and a FM radio support program 443.

If an input signal for activation is generated from an input unit 412 and a display unit 414 having a touch screen function, the RFID support program 441 is a program that is loaded to a controller 416 and supports the RFID function. That is, the RFID support program 441 can include routines that support a RFID system block 446 of the controller 416. For example, when an input signal for activation is generated, the RFID support program 441 supports to receive or transmit a signal that is necessary for supporting the RFID function using a RFID antenna pattern 151 which is prepared between the first cover unit antenna connection point 221 and the second cover unit antenna connection point 223 (FIG. 1).

The FM radio support program 443 is a program that is loaded to the controller 416 and supports the FM radio function if an input signal for activation is generated from the input unit 412 and the display unit 414 having a touch screen function. Such a FM radio support program 443 can include routines that support a FM radio system block 447 of the controller 416. That is, if an input signal for activation is generated, the FM radio support program 443 can support to receive or transmit a signal that is necessary for supporting the FM radio function using a FM radio antenna pattern 153 that is prepared between the first cover unit antenna connection point 221 and the third cover unit antenna connection point 225 (FIG. 1).

The data area, as an area where data generated according to the user of the portable device 400 is stored, can store phone book information, one or more icons according to widget function and various sets of content. Further, in case the display unit 414 is manufactured in the form of a touch screen, the data area can store a user input inputted through the touch screen. In particular, the data area of the present invention can store data received according to the operation of the RFID function, or can store data received according to the operation of the FM radio function.

The single unit antenna 150 is constituted in one antenna pattern form, and can operate as a RFID antenna pattern 151 or as a FM radio antenna pattern 153 depending on the connection point.

That is, as illustrated in FIGS. 1 through 3, an antenna pattern between the first cover unit antenna connection point 221 and the second cover unit antenna connection point 223 can operate as a RFID antenna pattern 151, and an antenna pattern between the first cover unit antenna connection point 221 and the third covert unit antenna connection pattern 223 can operate as a FM radio antenna pattern 153 that supports RM radio function (FIG. 1).

The controller 416 can support to perform an initialization process by controlling power supply to each component of the portable device 400, and can control the single unit antenna 150 for various functions to be operated as one of a RFID function and a FM radio function according to a generated input signal when the initialization process is completed. To this end, the controller 416 can include a RFID system block 446 and a FM radio system block 447.

The RFID system block 446 is a block that supports the single unit antenna 150 for various functions to be operated as a RFID antenna pattern 151 if an input signal for operation of the RFID operation is generated from the input unit 412, and the like.

Such a RFID system block 446 can support a RFID tag function and a RFID reader function depending on whether the portable device supports the function. In order to support the RFID tag function, the RFID system block 446 can manage connection points so that the single unit antenna 150 for various functions can be basically used as the RFID antenna pattern 151 in a state where the battery cover unit is coupled with the main body. That is, the RFID system block 446 can be connected to the first main body antenna connection point 121 and the second main body antenna connection point 123, and can support to receive a signal that recognizes the portable device 400 as a tag from the outside. Further, in case the RFID reader function is intended to be performed according to a user request, the RFID system block 446 can support transmission and reception of signals that are necessary for operation of the reader function based on the first main body antenna connection point 121, the second main body antenna connection point 123, the first cover unit antenna connection point 221, the second cover unit antenna connection point 223, and the single unit antenna 150 for various functions.

If an input signal for performance of a FM radio function is generated in the input unit 412, etc., the FM radio system block 447 can restrict the RFID function and support to perform the FM radio function based on the FM radio antenna pattern 153. That is, in the state where the battery cover unit 200 is coupled with the main body 100, the FM radio system block 447 can control to receive a signal for supporting the FM radio function based on the first main body antenna connection point 121, the third main body antenna connection point 125, the first cover unit antenna connection point 221, the third cover unit antenna connection point and a portion of the pattern of the single unit antenna 150 for various functions.

Here, in case the single unit antenna 150 for various functions and the third cover unit antenna connection point 225 are not directly connected to each other, the FM radio system block 447 can support to operate the single unit antenna 150 for various functions as the FM radio antenna pattern 153 based on the fourth cover antenna connection point 227 disposed at one end of the single unit antenna 150 for various functions and a signal line that connects the fourth cover antenna connection point 227 and the third cover antenna connection point 225.

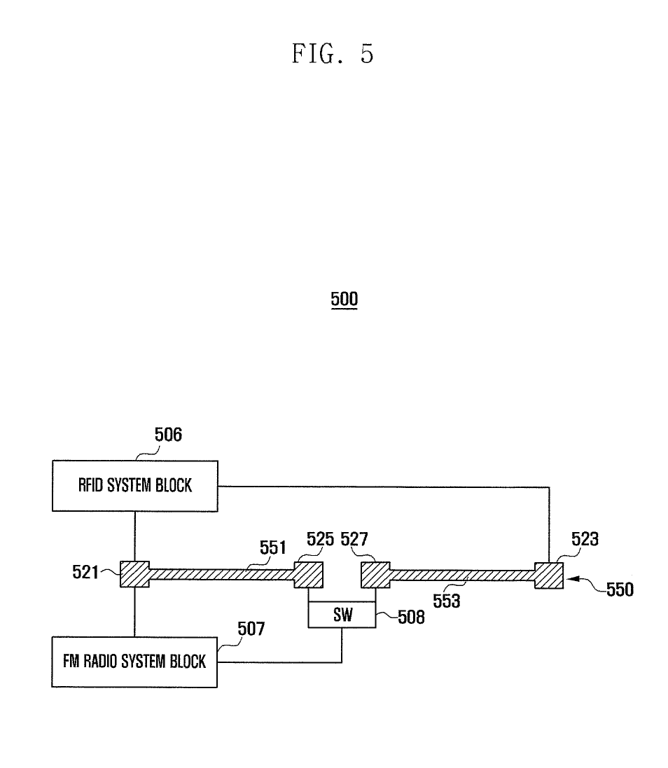

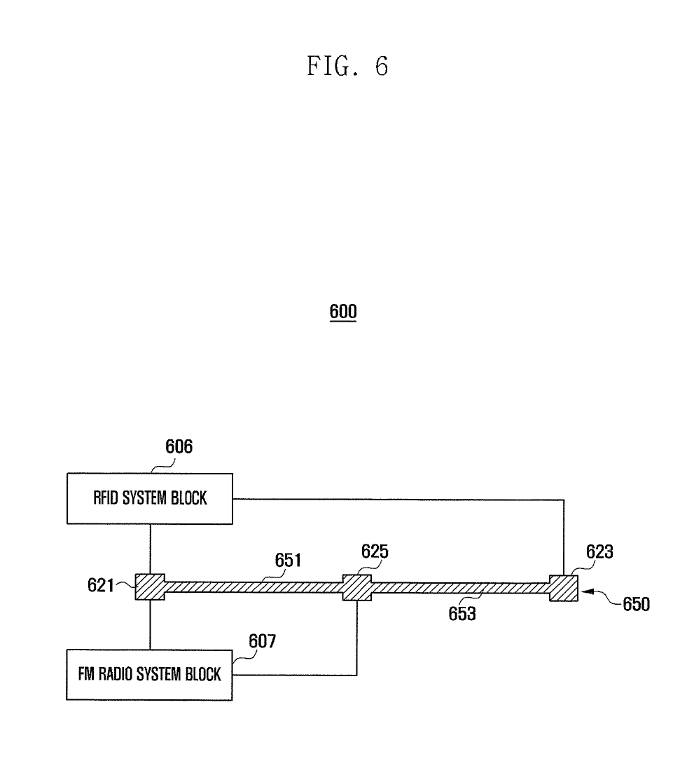

The operation of the single unit antenna 150 for various functions will be explained in more detail with reference to FIGS. 5 and 6.

FIG. 5 illustrates an example single unit antenna 550 according to an embodiment of the present invention. For simplicity, the single unit antenna 550 will be described and shown as straight having no curves. However, the present embodiment is not limited to this example, and the single unit antenna 550 may any shape or form, such as a zigzag form having many curves or a cochlea form.

Referring FIG. 5, the single unit antenna 550 can include a front side antenna pattern 551 and a rear side antenna pattern 553, and a switch 508 that selectively connects the front side antenna pattern 551 and the rear side antenna pattern 553.

The front side antenna pattern 551 can include a first antenna connection point 521 and a third antenna connection point 525. Further, the rear side antenna pattern 553 can include the fourth antenna connection point 527 and the second antenna connection point 523. Further, the portable device can include a FM radio system block 507 that supports operation of the FM radio function based on the front side antenna pattern 551, and can include a RFID system block 506 that supports operation of the RFID function based on the front side antenna pattern 551, the rear side antenna pattern 553 and the switch 508.

In case the RFID function is operated, the portable device having such a configuration according to the present invention can maintain the turn-on state of the switch 508 and operate the front side antenna pattern 551 and the rear side antenna pattern 553 as one RFID antenna pattern according to the control of the RFID system block 506. In case the FM radio function is operated, the portable device of the present invention can maintain the turn-off state of the switch 508 and operate the front side antenna pattern 551 as the FM radio antenna pattern according to the control of the FM radio system block 507. In case the RFID function is provided as a basic function and the FM radio function is selectively operated, the switch 508, which is constituted as a P-type, supports the RFID function at ordinary times by connecting the front side antenna pattern 551 and the rear side antenna pattern 553, and the switch 508 can be controlled to operate only the front side antenna pattern 551 when operating the FM radio function.

Each connection point of the single unit antenna shown in FIG. 5 can be connected to the main body antenna connection points disposed at the main body, and can selectively support various functions that use an antenna. For example, the first antenna connection point 521 can be connected to the first main body antenna connection point 121, the second antenna connection point 523 can be connected to the second main body antenna connection point 123, and the third antenna connection point 525 can be connected to the third main body antenna connection point 125 as shown in FIG. 1.

A signal line for controlling the switch 508 can be further disposed at the battery cover unit, and a cover unit switch connection point can be further disposed at the end of the signal line for controlling the switch 508 at one end of the battery cover unit. Further, the main switch connection point, which is connected to the switch connection point, can be disposed at the main body, and a control signal for the switch control can be transmitted from the controller to the switch 508 via the main switch connection point and the cover switch connection point. Then the portable device of the present invention can operate an antenna pattern including the front side antenna pattern and the rear side antenna pattern for supporting one of the first user function and the second user function through controlling the switch 508.

Further, the portable device of the present invention does not divide the single unit antenna 550 for various functions into the front side antenna pattern 551 and the rear side antenna pattern 553 disposed away from each other based on the switch 508, and can support operation of various user functions by connecting the front side antenna pattern 551 and the rear side antenna pattern 553 and operating only the connection points differently as illustrated in FIG. 6.

Specifically, as illustrated in FIG. 6, the single unit antenna 650 for various functions can include the first antenna connection point 621, the second antenna connection point 623 and the third antenna connection point 625, and can include the front side antenna pattern 651 that connects the first antenna connection point 621 and the third antenna connection point 625, and the rear side antenna pattern 653 that connects the third antenna connection point 625 and the second antenna connection point 623

Further, the RFID system block 606 can include a signal line that is connected to the first antenna connection point 621 and the second antenna connection point 623, and control to support the RFID function based on the front side antenna pattern 651 and the rear side antenna pattern 653 that connect the first antenna connection point 621 and the second antenna connect point 623.

Further, the FM radio system block 607 can include a signal line that is connected to the first antenna connection point 621 and the third antenna connection point 65, and can support the FM radio function based on the front side antenna pattern 651 that connects the first antenna connection point 621 and the third antenna connection point 625. Here, if compared with FIGS. 1 to 3, the first antenna connection point 621 can correspond to the contact point of the first main body antenna connection point 121 and the first cover unit antenna connection point 221, and the second antenna connection point 623 can correspond to the contact point of the second main body antenna connection point 123 and the second cover unit antenna connection point 223. Further, the third antenna connection point 625 can correspond to the contact point of the third main body antenna connection point 125 and the third cover unit antenna connection point 225.

In the above explanation, the single unit antenna 650 has been divided into the front side antenna pattern 651 and the rear side antenna pattern 653, but the present invention is not limited to this example. That is, the portable device including the single unit antenna 650 includes a pattern at one side of the battery cover unit, the entire antenna pattern is used for operating the first user function, and some antenna patterns can be used in operating the second user function. Further, the portable device of the present invention can divide the entire antenna pattern into two or more antenna patterns, include a switch, which connects the divided antenna patterns, to be used in operating the first user function, and only some antenna patterns can be used in operating the second user function through the switch control. Further, the portable device of the present invention includes multiple of connection points for one antenna pattern without a switch, and can support to selectively operate connection between connection points according to the user function by including the connection point for operating the entire antenna pattern and the connection point for using only some antenna patterns among the entire antenna patterns.

Further, the above-described portable device can further include the components, which are not mentioned above, such as a near field communication (NFC) module for near field communication, a camera module for taking a still picture/moving picture of an object, an interface for transmission and reception of data by a wire communication method or a wireless communication method of the portable device, an Internet communication module for performing Internet function by communicating with Internet network, and a digital broadcasting module for receiving and replaying a digital broadcast, and the like. Because such components can be variously modified due to the convergence trend of digital devices, not all such components can be listed here, but the components of a level same as that of the above-mentioned components can be further included in the device. Further, some of the components of the portable device of the present invention can be exempted or substituted by other components depending on the provided type, which can be easily understood by those skilled in the art.

Further, the portable device according to an embodiment of the present invention can include all types of devices that support user functions of the battery cover unit in a selective manner. For example, the portable device can include mobile communication terminals operated according to communication protocols corresponding to various communication systems, all information communication devices and multimedia devices and application devices thereof, such as a portable multimedia player (PMP), a digital broadcast player, a personal digital assistant (PDA), a music player (e.g., an MP3 player), a portable game terminal, a smart phone, a notebook computer and a handheld PC, and the like.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A portable device comprising:
a main body configured to house a battery;
a battery cover unit that is configured to be coupled with the main body and cover the battery; and
a single unit antenna for various functions having a specified length, the single unit antenna being disposed at one side of the battery cover unit and configured to support a plurality of user functions using an antenna.

2. The device of claim 1, wherein the single unit antenna comprises:
an antenna pattern of the single unit antenna having two ends;
a first cover unit antenna connection point formed at one of the ends of the antenna pattern, the one end having a specified surface area;
a second cover unit antenna connection point formed at the other end of the antenna pattern and having a specified surface area; and
a third cover unit antenna connection point disposed between the first cover unit antenna connection point and the second cover unit antenna point, the third cover unit antenna connection point formed on the antenna pattern with a specified surface area.

3. The device of claim 2, wherein the antenna pattern is divided into:
a first antenna pattern portion configured to support a radio-frequency identification (RFID) function using the first cover unit antenna connection point and the second cover unit antenna connection point; and
a second antenna pattern portion configured to support a FM radio function using the first cover unit antenna connection point and the third cover unit antenna connection point.

4. The device of claim 2, wherein the main body comprises:
a first main body antenna connection point that is formed on the main body and coupled to the first cover unit antenna connection point when the main body is coupled with the battery cover unit;
a second main body antenna connection point that is coupled to the second cover unit antenna connection point when the main body is coupled with the battery cover unit; and
a third main body antenna connection point that is coupled to the third cover unit antenna connection point when the main body is coupled with the battery cover unit.

5. The device of claim 1, wherein the single unit antenna further comprises:
an antenna pattern of the single unit antenna having two ends;
a first cover unit antenna connection point formed with a specified surface area at one of the ends of the antenna pattern;
a second cover unit antenna connection point formed with a specified surface area at the other end of the antenna pattern which is disposed at an area adjacent to one end of the antenna pattern;
a third cover unit antenna connection point formed with a specified surface area at one or more adjacent areas among the first cover unit antenna connection point and the second cover unit antenna point;
a fourth cover unit antenna connection point formed with a specified surface area at a specified point on the antenna pattern; and
a signal line that connects the third cover unit antenna connection point and the fourth cover unit antenna connection point.

6. The device of claim 5, wherein the antenna pattern is divided into:
a first antenna pattern portion for supporting a RFID function using the first cover unit antenna connection point and the second cover unit antenna connection point; and
a second antenna pattern portion for supporting a FM radio function using the first cover unit antenna connection point and the third cover unit antenna connection point.

7. The device of claim 5, wherein the main body comprises:
a first main body antenna connection point formed at the main body and is connected to the first cover unit antenna connection point when the main body is coupled with the battery cover unit;
a second main body antenna connection point coupled to the second cover unit antenna connection point when the main body is coupled with the battery cover unit; and
a third main body antenna connection point coupled to the third cover unit antenna connection point when the main body is coupled with the battery cover unit.

8. The device of claim 1, wherein the single unit antenna comprises:
an antenna pattern of the single unit antenna that comprises a front side antenna pattern and a rear side antenna pattern which have a specified length and are disposed separately from each other;
a first antenna connection point formed with a specified surface certain area at one end of the front side antenna pattern, a second antenna connection point formed with a specified surface area at one end of the rear side antenna pattern, a third antenna connection point formed with a specified surface area at the other end of the front side antenna pattern, and a fourth antenna connection point formed with a specified surface area at the other end of the rear antenna pattern;
a switch that is disposed between the third antenna connection point and the fourth antenna connection point, the switch configured to selectively connect the third antenna connection point and the fourth antenna connection point;
a signal line for controlling the switch; and
a cover unit switch connection point formed with a specified surface area at the end of the signal line.

9. The device of claim 8, wherein the main body comprises:
a first main body antenna connection point that is coupled to the first antenna connection point;
a second main body antenna connection point that is coupled to the second antenna connection point;
a third main body antenna connection point that is coupled to the third antenna connection point; and
a main body switch connection point that is coupled to the cover unit switch connection point.

10. The device of claim 8, wherein the antenna pattern comprises:
a front side antenna pattern configured to support a FM radio function; and
a front side antenna pattern and a rear side antenna pattern configured to support a RFID function.

11. The device of claim 10, wherein the switch is configured to maintain an on state when supporting the RFID function and maintain an off state when supporting the FM radio function.

12. The device of claim 1, wherein the plurality of user functions comprise the RFID function and the FM radio function.

13. A single unit antenna comprising:
an antenna pattern having a specified length and extending across at least a portion of a battery cover unit;
a first antenna connection point and a second antenna connection point having a specified surface area at both end points of the antenna pattern; and
a third antenna connection point having a specified surface area on the antenna pattern between the first antenna connection point and the second antenna connection point.

14. The antenna of claim 13, wherein the entire antenna pattern connected between the first antenna connection point and the second antenna connection point is configured to resonate at a frequency band that supports a first user function, and a portion of the antenna pattern connected to the first antenna connection point and the third antenna connection point that is configured to resonate at a frequency band that supports a second user function.

15. The antenna of claim 14, wherein the antenna pattern is divided into:
a first antenna pattern portion that is configured to support a RFID function using the first antenna connection point and the second antenna connection point; and
a second antenna pattern portion configured to support a FM radio function using the first antenna connection point and the third antenna connection point.

16. The antenna of claim 13, wherein the antenna pattern is configured in a battery cover unit.

17. The antenna of claim 14, wherein the battery cover unit is configured to selectively cover a battery mounted in a main body.

18. A single unit antenna comprising:
an antenna pattern having a specified length and extending over at least a portion of a battery cover unit, the antenna pattern comprising a front side antenna pattern and a rear side antenna pattern which are placed separately from each other;
a first antenna connection point having a specified surface area at one end of the front side antenna pattern, a second antenna connection point having the specified surface area at one end of the rear side antenna pattern, a third antenna connection point having the specified surface area at the other end of the front side antenna pattern, and a fourth antenna connection point having the specified surface area at the other end of the rear side antenna pattern; and
a switch that is disposed between the third antenna connection point and the fourth antenna connection point, the switch configured to selectively couple the third antenna connection point and the fourth antenna connection point.

19. The antenna of claim 18, wherein the entire antenna pattern connected between the first antenna connection point, the switch and the second antenna connection point is configured to resonate at a frequency band that supports a first user function, and the front side antenna pattern is configured to resonate at a frequency band that supports a second user function.

20. The antenna of claim 19, wherein the first user function comprises a RFID function, and the second user function comprises a FM radio function.
